(19) United States
(12) Patent Application Publication
(10) Pub. No.: US 2005/0136906 A1
(43) Pub. Date: Jun. 23, 2005

(54) Mobile telephone terminal employing diversity

(75) Inventor: Toshiyuki Azuma, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/006,962

(22) Filed: Dec. 8, 2004

(30) Foreign Application Priority Data
Dec. 18, 2003 (JP) 2003-421094

(51) Int. Cl. H04B 1/38

(52) U.S. Cl. 455/418; 455/73

(57) ABSTRACT

The mobile phone contains: a transmitting and receiving unit including a transmitter circuit and a receiver circuit sharing a transmitting and receiving antenna, a receiver circuit having a receiving antenna, and a controller; and a control unit which can be coupled to the transmitting and receiving unit and which has a main controller transmitting communication data from and to the controller to selectively supply an AT command to the controller at the time of being coupled to the transmitting and receiving unit. The transmitting and receiving unit performs diversity reception operation using two receiver circuits, and when a request by the AT command is input from the control unit, the transmitting and receiving unit performs single reception operation where only one receiver circuit operates.

### BACKGROUND OF THE INVENTION

1. Field of the Invention

The present invention relates to a mobile phone which comprises a transmitting and receiving unit performing diversity reception and which can selectively couple the transmitting and receiving unit to a control unit, and more particularly, to a mobile phone which can switch operation of a transmitting and receiving unit from diversity reception to single reception when an external command is input to a control unit from the transmitting and receiving unit.

2. Description of the Related Art

Conventionally, mobile phones using a CDMA system referred to as CDMA2000 1× perform voice communication and packet data communication employing CDMA (1×) /FDD (code division multiple access system (1×) /frequency duplex) as a communication system and using a cellular frequency band of 800 MHz as a frequency band. In the mobile phones using such a kind of CDMA system, a transmitting and receiving unit for transmitting and receiving radio signals is provided with one transmitter circuit and one receiver circuit, and single reception is performed with the one receiver circuit.

On the other hand, mobile phones employing a CDMA system referred to as 1×ED-DO (1× EVolution-Data Optimized) mainly perform packet data communication using T-CDMA /FDD (time division multiple—code division multiple access system/frequency duplex) as a communication system and using a cellular frequency band of 800 MHz as a frequency band. In the mobile phones employing such a kind of CDMA system, a transmitting and receiving unit for transmitting and receiving radio signals is provided with one transmitter circuit and two receiver circuits, and diversity reception is preformed with the two receiver circuits. In such a kind of mobile phone performing the diversity reception, the throughput (data rate) of the transmitting and receiving unit is more improved than that of the mobile phone performing the single reception.

Since the mobile phones using the 1×ED-DO CDMA system diversity-receive radio signals using two receiver circuits provided in the transmitting and receiving unit, the two receiver circuits must be always kept in a working state, so that operation current used in the two receiver circuits is increased to two times the operation current used in the one receiver circuit of the CDMA2000 1× CDMA system. In the mobile phone employing such a kind of CDMA system, when the mobile phone is carried, the driving power is obtained from a built-in battery having a small power capacity. Accordingly, when the two receiver circuits are activated for a relative long time and diversity-receive the radio signals, power consumption of the battery is rapidly increased with increase in operation current of the two receiver circuits, so that duration of the battery is drastically shortened.

In the mobile phone performing the diversity reception using two receiver circuits, in order to suppress the drastic power consumption of the battery, there has been suggested a mobile phone that when radio signals are diversity-received and the reception state of the radio signals satisfies a predetermined condition, the diversity reception by two receiver circuits is switched to single reception by one receiver circuit, and power supply to the receiver circuit which has been deactivated at the time of the switching is stopped. An example of such a mobile phone is disclosed in Japanese Unexamined Patent Application Publication No. 2000-183793.

The mobile phone disclosed in Japanese Unexamined Patent Application Publication No. 2000-183793 comprises a first diversity unit and a second diversity unit having individual antennas, respectively. When the diversity reception is preformed, both of the first diversity unit and the second diversity unit are set to an activated state, and when the single reception is performed, any one of the first diversity unit and the second diversity unit, for example, only the first diversity unit, is set to an activated state, so that the single reception is performed by only the first diversity unit and the power supply to the second diversity unit is stopped.

In this case, the mobile phone disclosed in Japanese Unexamined Patent Application Publication No. 2000-183793 switches the diversity reception by both of the first diversity unit and the second diversity unit to single reception only by any one of the first diversity unit and the second diversity unit, when the reception state of radio signals satisfies a predetermined condition, specifically, when a communicating state is converted to a standby-reception state, when a state where a fading pitch is short due to high-speed data communication, etc. is converted to a state where the fading pitch is long due to low-speed data communication, when a signal reception level is switched from the outside of an adequate range where a signal reception level is not too high or too low to the inside of the adequate range, when quality of a used line is switched from a deteriorated state to a good state, when a state where a movement speed of a moving mobile phone is high is converted to a state where the movement speed is low, and when a distance between the mobile phone and a base station is switched from the outside of an adequate range to the inside of the adequate range. Accordingly, it is possible to avoid increase in power consumption of a battery while maintaining relatively high transmission quality.

The mobile phone disclosed in Japanese Unexamined Patent Application Publication No. 2000-183793 can avoid the increase in power consumption of the battery while maintaining the relatively high transmission quality. However, it is required that as detection means for detecting whether the reception state of radio signals satisfies a predetermined condition, various detectors such as a fading pitch detector for detecting a fading pitch during use of the terminal, a reception level detector for detecting a reception level during use of the terminal, a line quality detector for detecting line quality during use of the terminal, a speed detector for detecting a movement speed of the local station during movement, a distance detector for detecting a distance between the local station and a base station, etc. should be additionally disposed in the mobile phone. Accordingly, since the mobile phone disclosed in Japanese Unexamined Patent Application Publication No. 2000-183793 should be additionally provided with various detectors, it is difficult to relatively simplify the structure of the mobile phone, so that manufacturing cost thereof is increased as much.

[Patent Document 1] Japanese Unexamined Patent Application Publication No. 2000-183793

### SUMMARY OF THE INVENTION

The present invention is contrived in view of the aforementioned technical background, and it is an object of the present invention to provide a mobile phone in which diversity reception and single reception can be converted to each other, power consumption of a battery can be reduced and a structure can be simplified using minimum additional circuits, and manufacturing cost can be reduced.

In order to achieve the above object, according to an aspect of the present invention, there is provided a mobile phone comprising: a transmitting and receiving unit including a transmitter circuit and a receiver circuit sharing a transmitting and receiving antenna, a second receiver circuit having a receiving antenna, and a controller connected to the transmitter circuit, the receiver circuit, and the second receiver circuit, respectively; and a control unit which is coupled to the transmitting and receiving unit and has a main controller transmitting communication data from and to the controller to selectively supply an external command to the controller when the control unit is coupled to the transmitting and receiving unit, wherein at the time of normal operation, the transmitting and receiving unit performs diversity reception operation using the receiver circuit and the second receiver circuit, and when a request by the external command is input from the control unit, the transmitting and receiving unit switches the diversity reception operation to single reception operation where only one of the receiver circuit and the second receiver circuit operates and the other of the second receiver circuit and the receiver circuit does not operate.

According to the aforementioned aspect of the present invention, in the mobile phone, when a request by the external command is input to the transmitting and receiving unit through manipulation of the control unit while the diversity reception is performed using the receiver circuit and the second receiver circuit, the diversity reception by the receiver circuit and the second receiver circuit is converted to the single reception using only one of the receiver circuit and the second receiver circuit, and the power supply to the receiver circuit not used as a result of the conversion. Accordingly, the power consumption of the battery can be reduced as much, thereby elongating the lifetime of the battery. In addition, when the diversity reception is converted to the single reception, the conversion can be performed in response to the request by using the external command from the control unit, thereby allowing the additional circuits for the conversion to be as small as possible. Accordingly, it is possible to reduce the manufacturing cost, as well as to simplify the structure of the mobile phone.

### BRIEF DESCRIPTION OF THE DRAWINGS

FIG. 1 is a block diagram illustrating an embodiment of a mobile phone according to the present invention.

### DESCRIPTION OF THE PREFERRED EMBODIMENT

Hereinafter, embodiments of the present invention will be described with reference to the drawings.

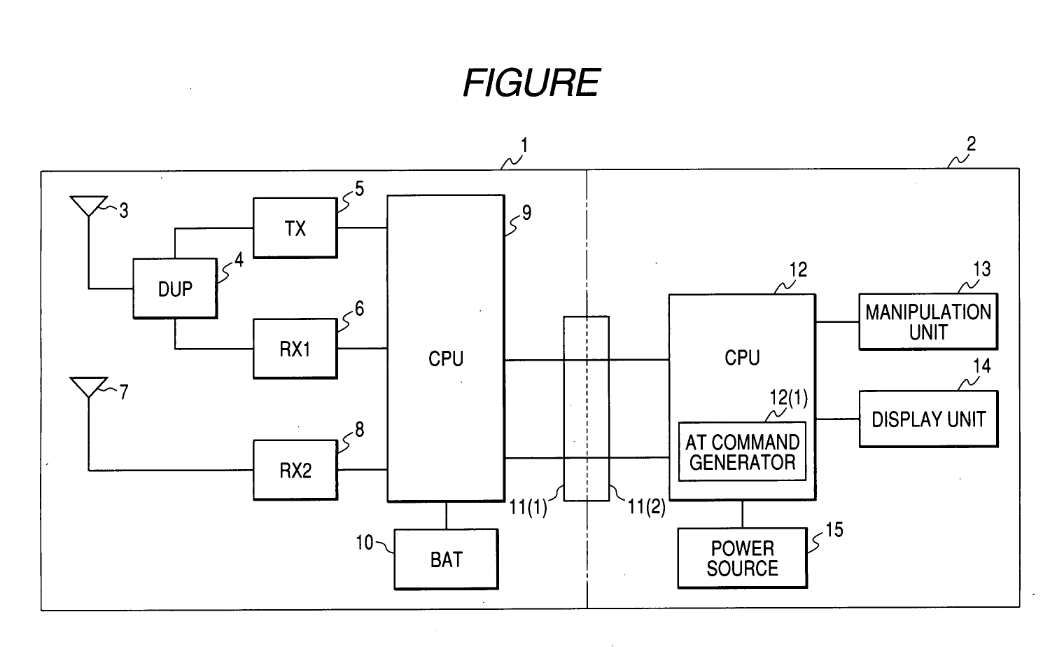

FIG. 1 is a block diagram illustrating an embodiment of a mobile phone according to the present invention.

As shown in FIG. 1, the mobile phone according to the present embodiment comprises a transmitting and receiving unit 1 and a control unit 2. In this case, the transmitting and receiving unit 1 comprises a transmitting and receiving antenna 3, a transmitting and receiving signal duplexer (DUP) 4, a transmitter circuit TX 5, a first receiver circuit RX1, a receiving antenna 7, a second receiver circuit RX2 8, a controller (CPU) 9, a battery (BAT) 10, and a unit coupler 11(1). The control unit 2 comprises a unit coupler 11(2), a main controller (CPU) 12, a manipulation unit 13, a display unit 14, and a power source 15. Furthermore, the controller 9 has a power supply controller 9(1) selectively switching power supply and power non-supply to the second receiver circuit 8 and a memory (not shown) such as ROM, RAM, etc. The main controller 12 has an AT command generator 12(1) selectively generating an AT command and a memory such as ROM, RAM, etc.

In the transmitting and receiving unit 1, signal input and output terminals of the transmitting and receiving signal duplexer 4 are connected to the transmitting and receiving antenna 3, the signal input terminal is connected to a signal output terminal of the transmitter circuit 5, and the signal output terminal is connected to a signal input terminal of the first receiver circuit 6. A signal input terminal of the transmitter circuit 5 is connected to the controller 9, and a signal output terminal of the first receiver circuit 6. A signal input terminal of the second receiver circuit 8 is connected to the receiving antenna 7, and a signal output terminal thereof is connected to the controller 9. The battery 10 is connected to the controller 9 through a power source line (not denoted by any reference numeral) and the unit coupler 11(1) is connected to the controller 9 through a data line and a power source line (all not denoted by any reference numeral).

In the control unit 2, a control output terminal of the manipulation unit 13 is connected to the main controller 12 and a display signal input terminal of the display unit 14 is connected to the main controller 12. The power source 15 is connected to the main controller 12 through a power source line (not denoted by any reference numeral) and the unit coupler 11(2) is connected to the main controller 12 through a data line and a power source line (all not denoted by any reference numeral).

The unit coupler 11(1) of the transmitting and receiving unit 1 and the unit coupler 11(2) of the control unit 2 can be locked to each other and can selectively couple or decouple the transmitting and receiving unit 1 and the control unit 2. When the transmitting and receiving unit 1 and the control unit 2 are coupled to each other, the data line and the power source line connected to the unit coupler 11(1) of the transmitting and receiving unit 1 are connected to the data line and the power source line connected to the unit coupler 11(2) of the control unit 2, respectively. On the other hand, when the transmitting and receiving unit 1 and the control unit 2 is decoupled from each other, the data line and the power source line connected to the unit coupler 11(1) of the transmitting and receiving unit 1 are separated from the data line and the power source line connected to the unit coupler 11(2) of the control unit 2, respectively.

The mobile phone having the aforementioned structure operates as follows.

First, operation when the unit coupler 11(1) and the unit coupler 11(2) are locked to each other and the transmitting and receiving unit 1 and the control unit 2 are coupled each other will be described. At this time, all the constituent elements of the transmitting and receiving unit 1 are supplied with power, and thus all the constituent elements are activated. Similarly, all the constituent elements of the control unit 2 are supplied with power, and thus all the constituent elements are activated. At this time, as a power source for activating the transmitting and receiving unit 1, the built-in battery 10 may be selected and the power source 15 supplied from the control unit 2 may be selected.

When signal transmission is performed by the transmitting and receiving unit 1 and base-band communication data are supplied to the transmitter circuit 5 from the controller 9, the transmitter circuit 5 frequency-transforms the base-band communication data into a transmitting frequency and amplifies the base-band communication data up to a transmittable level. Then, the transmitter circuit supplies the transmission signals obtained above to the transmitting and receiving antenna 3 through the transmitting and receiving signal duplexer 4 and transmits the transmission signals as radio signals from the transmitting and receiving antenna 3.

When signal reception is performed by the transmitting and receiving unit 1, a receiver circuit system including the transmitting and receiving antenna 3 and the receiving antenna 7 and a receiver circuit system including the receiving antenna 7 and the second receiver circuit 8 receive radio signals with the same frequency transmitted from the same transmitter. Then, the reception signals received by the transmitting and receiving antenna 3 are supplied to the first receiver circuit through the transmitting and receiving signal duplexer 4. The first receiver circuit 6 demodulates the reception signals into base-band communication data and supplies the demodulated base-band communication data to the controller 9. Similarly, the reception signals received by the receiving antenna 7 are supplied to the second receiver circuit 8. The second receiver circuit 8 demodulates the reception signals into base-band communication data and supplies the demodulated base-band communication data to the controller 9. The signal reception at this time is the diversity reception operation using the first receiver circuit 6 and the second receiver circuit 8. Among two pieces of base-band communication data supplied to the controller 9, the base-band communication data piece having a better reception state is selected by the controller 9, as well known in the diversity reception, and the selected base-band communication data piece is supplied to necessary circuits.

When the transmitting and receiving unit 1 performs such diversity reception, the time when the diversity reception is performed may be elongated, and it may be determined that the power consumption of the built-in battery 10 in use is advanced or it may be determined that the reception state of radio signals to be diversity-received is improved. In this case, a user can switch the reception state of the mobile phone. That is, by manipulating the manipulation unit 13, the reception operation of the transmitting and receiving unit 1 can be switched from the diversity reception to the single reception in which only one receiver circuit, for example, the first receiver circuit 6 operates.

Specifically, when a user manipulates buttons of the manipulation unit 13 of the control unit 2 in accordance with a predetermined manipulation order, the AT command generator 12(1) built in the main controller 12 generates an AT command in response to the manipulation of the manipulation unit 13, and the generated AT command is transmitted to the controller 9 through the data line connected to the main controller 12. When the AT command is supplied, the controller 9 switches the power supply state of the power supply controller 9(1), thereby intercepting the power supply to the second receiver circuit 8. At this time, even when the power supply to the second receiver circuit 8 is intercepted and the second receiver circuit 8 is deactivated, the power supply to the first receiver circuit 6 is maintained and thus the first receiver circuit 6 continuously maintains the activated state, so that the radio signals can be received using only the first receiver circuit 6. In other words, the single reception operation is performed successively to the diversity reception operation.

Next, operation when the unit coupler 11(1) and the unit coupler 11(2) are unlocked and the transmitting and receiving unit 1 and the control unit 2 are decoupled from each other will be described. At this time, all the constituent elements of the transmitting and receiving unit 1 are supplied with power through the power supply by the built-in battery 10, and all the constituent elements are activated. Similarly, all the constituent elements of the control unit 2 are supplied with power through the power supply by the power source 15, and all the constituent elements are activated.

At this time, similarly to the aforementioned case, at the time of signal transmission of the transmitting and receiving unit 1, the transmission of radio signals is performed using the transmitting and receiving antenna 3 and the transmitter circuit 5. At the time of signal reception, similarly to the aforementioned case, the diversity reception is performed using the transmitting and receiving antenna 3, the first receiver circuit 6, the receiving antenna 7, and the second receiver circuit 8.

In the case of the signal reception by the transmitting and receiving unit 1, when the transmitting and receiving unit 1 performs the diversity reception, the lasting time of the diversity reception may be elongated, and it may be determined that the power consumption of the built-in battery 10 in use is advanced or it may be determined that the reception state of radio signals to be diversity-received is improved. In this case, when a user locks the unit coupler 11(1) of the transmitting and receiving unit 1 to the unit coupler 11(2) of the control unit 2 and manipulates the buttons of the manipulation unit 13 of the control unit 2 in accordance with a predetermined manipulation order, an AT command is transmitted to the controller 9 of the transmitting and receiving unit 1 from the main controller 12 of the control unit 2. Accordingly, similarly to the previous case, the reception operation of the transmitting and receiving unit 1 is switched from the diversity reception to the single reception in which only one receiver circuit, for example, the first receiver circuit 5 operates.

In this case, in order to restore the reception operation of the transmitting and receiving unit 1 to the diversity reception from the single reception, by making a request for release using the AT command by manipulation of the manipulation unit 13 of the control unit 2, the reception operation may be restored to the diversity reception. Alternatively, when deterioration of the reception state of the reception signals in the transmitting and receiving unit 1 is detected by the controller 9, the reception operation may be automatically restored to the diversity reception from the single reception on the basis of the detection result.

In this way, in the mobile phone according to the present embodiment, at the time of receiving signals, the diversity reception operation can be performed using two types of receiver circuit systems. During the diversity reception operation, in a case where a user determines that the power consumption of the built-in battery 10 is advanced or that the reception state of the reception signals to be diversity-received is continuously good, the diversity reception of the transmitting and receiving unit 1 can be converted to the single reception, by making a request to the transmitting and receiving unit 1 from the control unit 2 using the AT command. Accordingly, the power consumption of the built-in battery 10 by operation of two types of receiver circuit systems can be reduced to the power consumption of the built-in battery 10 by operation of one types of receiver circuit system, and thus it is possible to prevent the lifetime of the built-in battery 10 from being shortening as much.

In the mobile phone according to the present embodiment, since only the power supply controller 9(1) and the AT command generator 12(1) are additionally provided for switching the operation of two types of receiver circuit systems, the additional circuits can be limited to the minimum, and thus the whole structure can be simplified, so that it is possible to reduce the manufacturing cost.

Although it has been exemplified in the above embodiments that the second receiver circuit 8 is deactivated and only the first receiver circuit 6 is activated when the transmitting and receiving unit 1 performs the single reception, the receiver circuit to be deactivated in the present invention is not limited to the second receiver circuit 8, but the first receiver circuit 6 may be deactivated and the second receiver circuit 8 may be activated.

In addition, although it has been exemplified in the above embodiments that the AT command is used as an external command for switching the transmitting and receiving unit 1 to the single reception from the diversity reception, the external command used in the present invention is not limited to the AT command, but any external command other than the AT command may be used if only the external command can be generated by the control unit 2.

1. A mobile phone comprising:
a transmitting and receiving unit including a transmitter circuit and a first receiver circuit sharing a transmitting and receiving antenna, a second receiver circuit having a receiving antenna, and a controller connected to the transmitter circuit, the first receiver circuit, and the second receiver circuit, respectively; and
a control unit which is coupled to the transmitting and receiving unit and has a main controller transmitting communication data from and to the controller to selectively supply an external command to the controller when the control unit is coupled to the transmitting and receiving unit,
wherein at a time of normal operation, the transmitting and receiving unit performs diversity reception operation using the first receiver circuit and the second receiver circuit, and when a request by the external command is input from the control unit, the transmitting and receiving unit switches the diversity reception operation to single reception operation where only one of the first receiver circuit and the second receiver circuit operates and the other of the second receiver circuit and the first receiver circuit does not operate.

2. The mobile phone according to claim 1, wherein the external command supplied to the controller from the main controller is an AT command.

3. The mobile phone according to claim 2, wherein the AT command is obtained by means of manipulation of a manipulation unit connected to the main controller.

4. The mobile phone according to claim 1, wherein the transmitting and receiving unit uses a built-in battery as a power source.
